(19) United States
(12) Patent Application Publication
(10) Pub. No.: US 2022/0417591 A1
(43) Pub. Date: Dec. 29, 2022

(54) VIDEO RENDERING METHOD AND APPARATUS, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Yi XIAO, Beijing (CN); Peihong HOU, Beijing (CN)

(21) Appl. No.: 17/889,817

(22) Filed: Aug. 17, 2022

Related U.S. Application Data
(63) Continuation of application No. PCT/CN2020/137398, filed on Dec. 17, 2020.

(30) Foreign Application Priority Data
Mar. 24, 2020 (CN) 202010212800.5

(51) Int. Cl. H04N 21/44

(52) U.S. Cl. CPC H04N 21/44016; H04N 21/44012

(57) ABSTRACT

A video rendering method is provided. The method includes acquiring a first video which is to be rendered and a material video for rendering the first video, wherein the material video is obtained by splicing and combining at least two video effects, and each of the video effects comprises a plurality of material pictures. The method further includes disassembling a plurality of material blocks from the material video, each of the material blocks being obtained by sequentially arranging a plurality of material pictures belonging to a same video effect, determining target positions of the material blocks in a video frame of the first video, and acquiring a second video by superimposing the material blocks on the target position of the video frame to complete video rendering.

### CROSS-REFERENCE TO RELATED APPLICATION

This application is a continuation application of International Application PCT/CN2020/137398, filed Dec. 17, 2020, which claims priority to Chinese Patent Application No. 202010212800.5, titled “VIDEO RENDERING METHOD AND APPARATUS, ELECTRONIC DEVICE, AND STORAGE MEDIUM”, filed with the China National Intellectual Property Administration on Mar. 24, 2020, the entire content of which is incorporated herein by reference.

### FIELD

The present disclosure relates to the field of video processing, and more particularly to a video rendering method, a video rendering apparatus, an electronic device, and a storage medium.

### BACKGROUND

With the development of hardware and software technologies for devices such as smartphones, device rendering of short videos is becoming more and more popular. When video effects are used to render videos, how to better implement video processing has become an urgent problem to be solved.

### SUMMARY

According to a first aspect of embodiments of the present disclosure, there is provided a video rendering method, including acquiring a first video which is to be rendered and a material video for rendering the first video, in which the material video is obtained by splicing and combining at least two video effects, and each of the video effects includes a plurality of material pictures. The method further includes disassembling a plurality of material blocks from the material video, each of the material blocks being obtained by sequentially arranging a plurality of material pictures belonging to a same video effect, determining target positions of the material blocks in a video frame of the first video, and acquiring a second video by superimposing the material blocks on the target positions of the video frame to complete video rendering.

According to a second aspect of embodiments of the present disclosure, there is provided an electronic device, including a processor, and a memory for storing instructions executable by the processor, in which the processor is configured to acquire a first video which is to be rendered and a material video for rendering the first video, in which the material video is obtained by splicing and combining at least two video effects, and each of the video effects includes a plurality of material pictures. The processor is further configured to disassemble a plurality of material blocks from the material video, each of the material blocks being obtained by sequentially arranging a plurality of material pictures belonging to a same video effect, determine target positions of the material blocks in a video frame of the first video, and acquire a second video by superimposing the material blocks on the target positions of the video frame to complete video rendering.

According to a third aspect of embodiments of the present disclosure, there is provided a storage medium having stored therein instructions that, when executed by a processor of an electronic device, cause the electronic device to acquire a first video which is to be rendered and a material video for rendering the first video, in which the material video is obtained by splicing and combining at least two video effects, and each of the video effects includes a plurality of material pictures. The processor is further configured to disassemble a plurality of material blocks from the material video, each of the material blocks being obtained by sequentially arranging a plurality of material pictures belonging to a same video effect, determine target positions of the material blocks in a video frame of the first video, and acquire a second video by superimposing the material blocks on the target positions of the video frame to complete video rendering.

According to a fourth aspect of embodiments of the present disclosure, there is provided a computer program product including a computer program stored in a readable storage medium. When the computer program is read from the readable storage medium and executed by at least one processor of a device, the device acquires a first video which is to be rendered and a material video for rendering the first video, in which the material video is obtained by splicing and combining at least two video effects, and each of the video effects includes a plurality of material pictures. The device further disassembles a plurality of material blocks from the material video, each of the material blocks being obtained by sequentially arranging a plurality of material pictures belonging to a same video effect, determines target positions of the material blocks in a video frame of the first video, and acquires a second video by superimposing the material blocks on the target positions of the video frame to complete video rendering.

It should be understood that the foregoing general description and the following detailed description are exemplary and explanatory only and are not restrictive of the present disclosure.

### BRIEF DESCRIPTION OF THE DRAWINGS

The accompanying drawings herein are incorporated into and constitute part of the description, show embodiments consistent with the present disclosure, and are used with the description to explain the principles of the present disclosure and do not constitute an undue limitation of the present disclosure.

FIG. 1 is a schematic diagram of an animation effect of a video effect.

FIG. 2 is a schematic diagram of a material picture of a video effect.

FIG. 3 is a schematic diagram of a material picture of another video effect.

FIG. 4 is an internal structure diagram showing an electronic device according to an exemplary embodiment.

FIG. 5 is a flowchart showing a video rendering method according to an exemplary embodiment.

FIG. 6 is a schematic diagram showing the placement of material pictures of a certain frame of a material video according to an exemplary embodiment.

FIG. 7 is a schematic diagram of calculation of a current material video memory.

FIG. 8 is a schematic diagram showing calculation of a material video memory according to an exemplary embodiment.

FIG. 9 is a schematic diagram showing calculation of first position coordinates according to an exemplary embodiment.

FIG. 10 is a schematic diagram showing a mapping between a material picture and a target effect picture according to an exemplary embodiment.

FIG. 11 is a schematic diagram showing a superposition of a text picture according to an exemplary embodiment.

FIG. 12 is a schematic diagram showing a superposition of a firework material according to an exemplary embodiment.

FIG. 13 is a schematic diagram showing a video rendering effect according to an exemplary embodiment.

FIG. 14 is a diagram showing a processing flow of a material picture according to an exemplary embodiment.

FIG. 15 is a block diagram showing a video rendering apparatus according to an exemplary embodiment.

### DETAILED DESCRIPTION

In order to make those skilled in the art better understand the technical solutions of the present disclosure, the technical solutions in the embodiments of the present disclosure will be clearly and completely described below with reference to the accompanying drawings.

It should be noted that the terms “first”, “second” and the like in the description and claims of the present disclosure and the above accompanying drawings are used to distinguish similar objects, and are not necessarily used to describe a specific sequence or precedence order. It should be understood that the data so used are interchangeable under appropriate circumstances so that the embodiments of the disclosure described herein can be practiced in sequences other than those illustrated or described herein. The implementations described in the illustrative examples below are not intended to represent all implementations consistent with this disclosure. Rather, they are merely examples of apparatus and methods consistent with some aspects of the present disclosure as recited in the appended claims.

The present disclosure provides a video rendering method, a video rendering apparatus, an electronic device, and a storage medium to at least solve the problem in the related art of device freeze caused by too much memory space occupied due to the fact that a frame sequence rendering method is still necessary because two material videos cannot be decoded at the same time when two or more video effects need to be used to render a video.

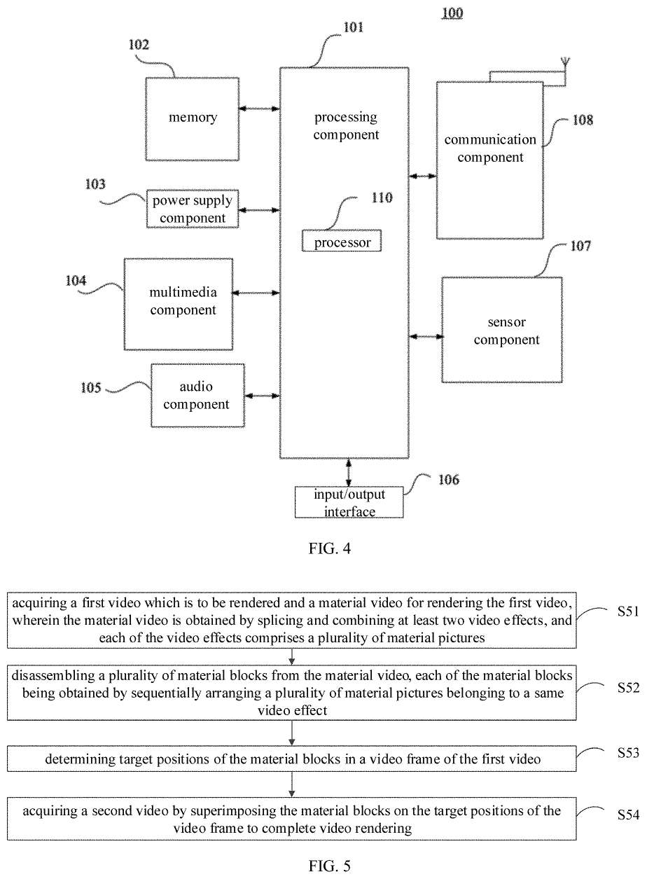

The video rendering method provided by the present disclosure can be applied to a device 100 shown in FIG. 4. The device 100 may be a mobile device such as a mobile phone, a computer, a digital broadcast terminal, a messaging device, a game console, a tablet device, a medical device, a fitness device, a personal digital assistant, and the like.

Referring to FIG. 4, the device 100 may include one or more of the following components: a processing component 101, a memory 102, a power supply component 103, a multimedia component 104, an audio component 105, an input/output (I/O) interface 106, a sensor component 107, and a communication component 108. These components are described in detail as follows:

The processing component 101 generally controls the overall operation of the device 100, such as operations associated with display, phone calls, data communications, camera operations, and recording operations. The processing component 101 may include one or more processors 110 to execute instructions to complete all or part of the steps of the above-described methods. Additionally, the processing component 101 may include one or more modules to facilitate interaction between the processing component 101 and other components. For example, the processing component 101 may include a multimedia module to facilitate interaction between the multimedia component 104 and the processing component 101.

The memory 102 is configured to store various types of data to support operations at the device 100. Examples of such data include instructions, contact data, phonebook data, messages, pictures, videos, and the like for any application program or method operating on the device 100. The memory 102 may be implemented by any type of volatile or non-volatile storage device or combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power supply component 103 provides power to various components of the device 100. The power supply component 103 may include a power management system, one or more power supplies, and other components associated with the generation, management, and distribution of power in the device 100.

The multimedia component 104 includes a screen that provides an output interface between the device 100 and a user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or swipe action, but also detect the duration and pressure associated with the touch or swipe operation. In some embodiments, the multimedia component 104 includes a front camera and/or a rear camera. When the device 100 is in an operation mode, such as a shooting mode or a video mode, the front camera and/or the rear camera may receive external multimedia data. Each of the front camera and the rear camera can be a fixed optical lens system or have focal length and optical zoom capability.

The audio component 105 is configured to output and/or input audio signals. For example, the audio component 105 includes a microphone (MIC) that is configured to receive external audio signals when the device 100 is in an operating mode, such as a call mode, a recording mode, and a voice recognition mode. The received audio signal may be further stored in the memory 102 or transmitted via the communication component 108. In some embodiments, the audio component 105 also includes a speaker for outputting audio signals.

The I/O interface 106 provides an interface between the processing component 101 and a peripheral interface module, which may be a keyboard, a click wheel, a button, and the like. The button may include, but are not limited to: a home button, a volume button, a start button, and a lock button.

The sensor component 107 includes one or more sensors for providing status assessment of various aspects of the device 100. For example, the sensor component 107 can detect an on/off state of the device 100, a relative positioning of components, for example, a display and a keypad of the device 100. The sensor component 107 may also detect a change in the position of the device 100 or a component of the device 100, the presence or absence of user contact with the device 100, the orientation or acceleration/deceleration of the device 100 and the temperature change of the device 100. The sensor component 107 may include a proximity sensor configured to detect the presence of nearby objects in the absence of any physical contact. The sensor component 107 may also include a light sensor, such as a CMOS or CCD picture sensor, for use in imaging applications. In some embodiments, the sensor component 107 may also include an acceleration sensor, a gyroscope sensor, a magnetic sensor, a pressure sensor, or a temperature sensor.

The communication component 108 is configured to facilitate wired or wireless communications between the device 100 and other devices. The device 100 may access wireless networks based on communication standards, such as WiFi, carrier networks (e.g., 2G, 3G, 4G, or 5G), or a combination thereof. In an exemplary embodiment, the communication component 108 receives broadcast signals or broadcast related information from an external broadcast management system via a broadcast channel. In an exemplary embodiment, the communication component 108 also includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology and other technologies.

In some embodiments, the device 100 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements for performing the above-mentioned video rendering method.

FIG. 5 is a flowchart showing a video rendering method according to an exemplary embodiment. As shown in FIG. 5, the video rendering method is used in the device 100 of FIG. 4.

In step S51, a first video which is to be rendered and a material video for rendering the first video are acquired; in which the material video is obtained by splicing and combining at least two video effects, and each of the video effects includes a plurality of material pictures.

The first video which is to be rendered is a video which needs to be added with a video effect. In this embodiment, two or more video effects need to be added to the first video. Each video effect is obtained by combining a plurality of material pictures.

In some embodiments, before the video is rendered in this embodiment, video effects need to be subjected to splicing and combining to obtain a material video. In some embodiments, the method may further include the following steps: acquiring at least two video effects; arranging text pictures belonging to a same text effect and to a same text as a text material block in response to at least one of the video effects being a text effect including text pictures containing text information; generating an alpha material block for the text material block, the alpha material block comprising alpha pictures in one-to-one correspondence to the text pictures of the text material block; and obtaining the material video by performing splicing and combining according to the text material block and the alpha material block.

Before rendering the first video, splicing and combining of the material video may be performed for the first video in an early stage, in which the material video is obtained by splicing and combining two or more video effects.

When splicing and combining of the material video is performed in the early stage, material pictures of the video effects can be neatly placed in the material video according to the effect requirements. For example, for material pictures belonging to the same video effect, the material pictures can be arranged according to the effect requirements, and then the material pictures can be combined into each frame of the material video one by one in the arranged order. For material pictures that appear at the same moment in a video frame but belong to different video effects, the material pictures are spliced and combined in the same frame of the material video.

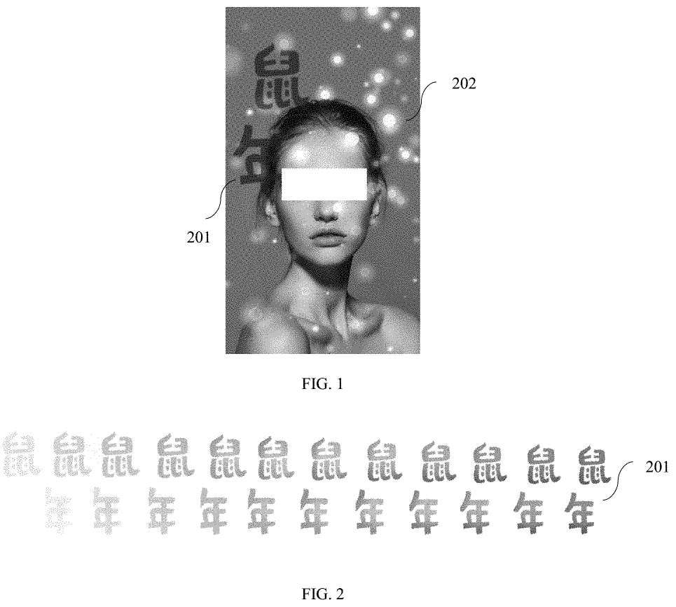

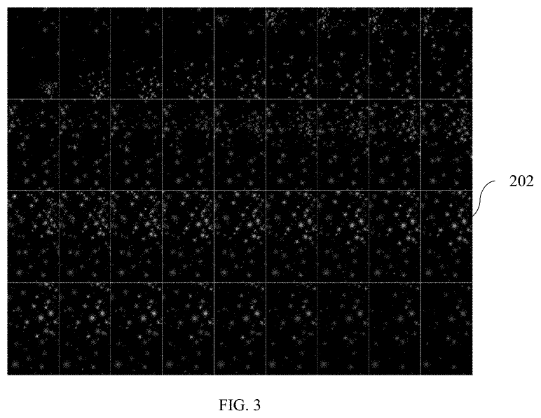

In some embodiments, the video effects include text effects and animation effects, in which the text effects include text pictures containing text information, such as the text effects of the two Chinese characters “Shu Nian” (Year of the Rat) as shown in FIG. 2, and the animation effects include material pictures of non-text pictures. For example, a firework effect can include fireworks pictures containing fireworks as shown in FIG. 3, and a flower effect can include flower pictures containing flowers. For example, as shown in FIG. 1, the video effects include text pictures of the two Chinese characters “Shu Nian” 201 as shown in FIG. 2, and fireworks pictures 202 containing fireworks as shown in FIG. 3.

Assume that there are firework pictures 202 with firework effects and text pictures with four sets of text effects, namely “Gong Xi Fa Cai” 203, “Shu Nian Kuai Le” 204, “Zhao Cai Jin Bao” 205, and “Da Ji Da Li” 206. When splicing and combining of a material video is performed, one can use popular video production software, such as After Effect (abbreviated as AE) for splicing and combination. In AE, referring to FIG. 6, the text pictures corresponding to individual texts in the text effects can be neatly placed (as shown on the left of FIG. 6 at 601), and the fireworks pictures with the fireworks effects also need to be neatly placed (as shown in the middle of FIG. 6 at 602).

FIG. 6 is a schematic diagram of the placement of material pictures in a certain frame of a material video. Each frame of the material video is spliced with text pictures and firework pictures that appear at the same moment. For example, for text pictures with text effects, the text pictures belonging to the same text can be placed in a grid area, and the grid space is multiplexed and the space is not left blank as much as possible to achieve the highest utilization of space. Of course, firework pictures with firework effects can also be placed in a grid area to achieve the highest utilization of space. The material pictures in the same grid area are sorted and combined into a material block. For example, in an area of a grid where a Chinese character “Shu” is located, all the text pictures of “Shu” are combined into a material block with the character “Shu”, and in an area of a grid where a firework are located, all the pictures of firework are combined into a material block with the “firework”.

In some embodiments, when a video is rendered with two or more video effects, it is necessary to acquire a first video and a pre-spliced and combined material video for the first video.

In step S52, a plurality of material blocks are disassembled from the material video; in which each of the material blocks are obtained by sequentially arranging a plurality of material pictures belonging to a same video effect.

In some embodiments, when the material video is used to render the first video, it is first necessary to disassemble each material picture in the material video, which can be operated in tools such as the vertex shader of Opengl.

When material pictures are spliced and combined to obtain the material video, the material pictures belonging to the same video effect are neatly placed in a grid area. Therefore, when material pictures are to be obtained from the material video, material blocks belonging to the same grid (the same first position coordinates in the material video) can be obtained, thereby obtaining the material pictures of the material blocks.

In step S53, target positions of the material blocks in a video frame of the first video are determined.

In some embodiments, the target position to be placed in the video frame of the video may be set for the material block, so as to obtain the desired ideal effect picture. For example, a material picture of a material block can be placed in the middle of the video frame of the first video, it can also be placed in the lower left corner of the video frame of the first video, or it can overlap with the entire video frame of the first video.

In step S54, a second video is acquired by superimposing the material blocks on the target positions of the video frame to complete video rendering.

After the target position of each material block in the material video in the video frame is determined, a second video is acquired by correspondingly superimposing the material blocks on the target positions of the video frame of the first video to implement video rendering.

In this embodiment, since at least two video effects are spliced and combined into the same material video, and then the material video is used to render the first video, the memory space occupied by the video effects for video rendering can be saved.

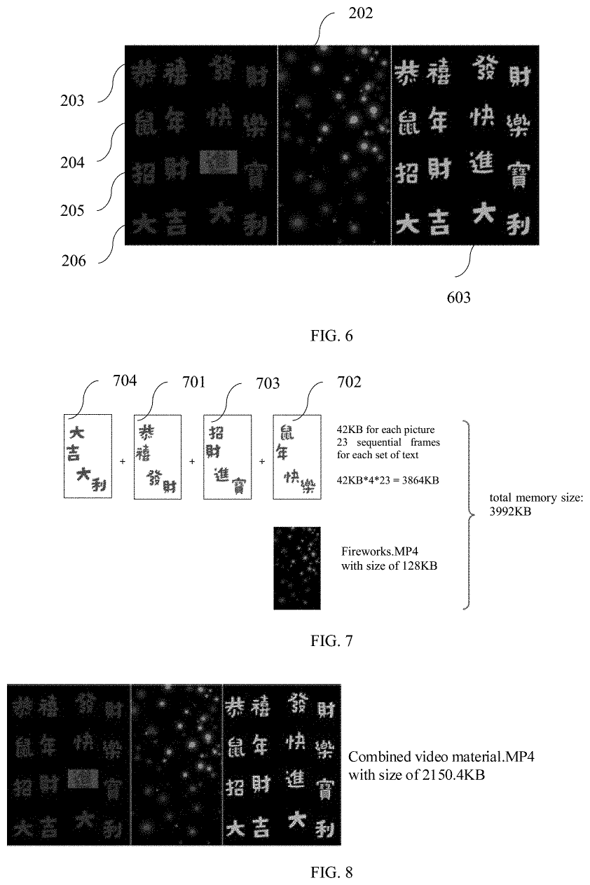

Referring to FIG. 7, assuming that there are firework pictures with firework effects and text pictures with four sets of text effects of “Gong Xi Fa Cai” 701, “Shu Nian Kuai Le” 702, “Zhao Cai Jin Bao” 703, and “Da Ji Da Li” 704, if the firework pictures with firework effects are converted to the material video, the size of the memory space occupied by the material video of the firework effect is 128 KB, and the text pictures with the four text effects are still frame sequences, then the size of the memory space occupied by the text pictures with the four text effects is 3864 KB, then the size of the total memory space that needs to be occupied is 3992 KB.

Referring to FIG. 8, by applying this embodiment, text pictures with four sets of text effects and fireworks pictures with fireworks effects are spliced and combined into the same material video (combined video material), and thus the size of the total memory space occupied is 2150.4 KB, which is 46.13% less than the way in which only one video effects can be converted into a video.

In the above-mentioned video rendering method, the first video and the material video used for rendering the first video are first acquired; in which the material video is obtained by splicing and combining a plurality of video effects, and each of the video effects includes a plurality of material pictures, a plurality of material blocks are disassembled from the material video, and target positions of the material blocks in the video frame of the first video is determined, and then a second video is acquired by superimposing the material block on the target positions of the video frame to complete the video rendering. In this way, the memory space occupied by the video effects used for video rendering can be saved, the device freeze can be avoided, and the fluency of video rendering can be improved.

In some embodiments, before the acquiring the first video and the material video for rendering the video, the method may further include the following steps: acquiring at least two video effects; arranging text material pictures belonging to a same text effect and to a same text as a text material block in response to at least one of the video effects being a text effect including text pictures containing text information; generating an alpha material block for the text material block, the alpha material block including alpha pictures in one-to-one correspondence to the text pictures of the text material block; and obtaining the material video by performing splicing and combining according to the text material block and the alpha material block. In the early stage of video splicing and combining, using video production software, text effects and other effects can be neatly placed in the material video. For example, referring to FIG. 6, the text pictures of individual texts in the text effects can be neatly placed, and the firework pictures with firework effects can be neatly placed.

It should be noted that since the material video does not have an alpha channel, and the mixing of text effects requires an alpha channel, it is also necessary to put the alpha channel of the text picture separately (as shown on the right of FIG. 6 at 603). Specifically, a respective alpha material block may be generated for the text material block, in which the alpha pictures in the alpha material block are in one-to-one correspondence to the text pictures in the text material block.

In some embodiments, the step S52 may specifically include the following steps: acquiring first position coordinates of each of the material blocks in the material video; and disassembling the material blocks from the material video according to the first position coordinates.

When the first video is rendered, each material picture in the material video needs to be disassembled, which can be operated in the vertex shader of Opengl. The material picture can be divided into small grids (material blocks) one by one, and then in acquiring the material picture, it can be acquired according to the material blocks, so that a plurality of material pictures belonging to the same video effect can be obtained at one time.

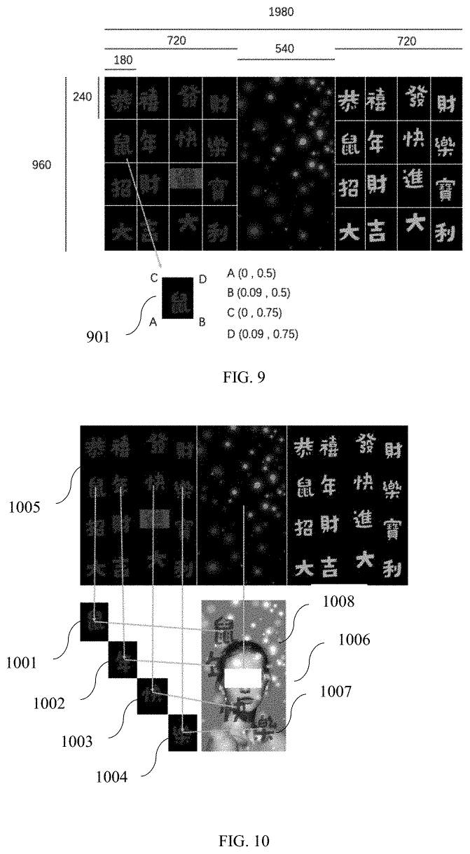

Referring to FIG. 9, the width and height (pixel value 960*1980) of a material video are known, and the width and height (pixel value) of each grid is also known, assuming that the material picture of the “Shu” material block 901 is to be taken out, the numerical range of the coordinates is 0 to 1. Assuming that the horizontal direction is the x-axis, the vertical direction is the y-axis, and four points of a grid where the “Shu” material block 901 is located are A, B, C and D, for example, for A point in the lower left corner of the “Shu” 901, its x coordinate is 0, and its y coordinate is 480/960=0.5; for another example, for D point in the upper right corner of the “Shu” 901, its x coordinate is 180/1980=0.09, and its y coordinate is 240*3/960=0.75. According to the same method, the position coordinates of the four points A, B, C and D of the “Shu” material block 901 in the material video are calculated, respectively. After the position coordinates of the four points A (0, 0.5), B (0.09, 0.5), C (0, 0.75), D (0.09, 0.75) are obtained, the “Shu” material block 901 can be taken out separately, so as to take out the “Shu” material block 901. Similarly, other material blocks in the material video can be taken out.

In some embodiments, the step S53 may specifically include the following steps: acquiring a coordinate mapping relationship, the coordinate mapping relationship being a mapping relationship between the first position coordinates of the material blocks in the material video and second position coordinates of the material blocks in the video frame of the first video; determining the second position coordinates corresponding to the first position coordinates according to the coordinate mapping relationship; and taking as the target position a position where the second position coordinates are located.

When the material video is obtained by splicing and combining, the original arrangement position of the material picture is disturbed, so the extracted material picture needs to be repositioned. In this embodiment, a one-to-one correspondence coordinate mapping relationship is established between the material video and the ideal effect picture in advance. According to the first position coordinates of the material picture in the material video, the second position coordinates of the material picture in the video frame of the first video can be determined based on the coordinate mapping relationship as the target position of the material block in the video frame of the first video.

As shown in FIG. 10, a coordinate mapping relationship is established according to the desired target effect picture, and thus four Chinese characters “Shu” 1001, “Nian” 1002, “Kuai” 1003 and “Le” 1004 are moved from four points (first position coordinates) in the material video 1005 to four points (second position coordinates) in the first video 1006, respectively.

After the second position coordinates of the material picture 1007 in the video frame 1008 are determined according to the established coordinate mapping relationship, the material picture 1007 can be superimposed into the second coordinate position of the video frame 1008. After moving to the video frame 1008 of the first video 1006, it can be seen that the background of the material picture 1007 is black. This involves the superposing and mixing of the material picture 1007 and the video frame 1008 of the first video 1006. It should be noted that the superimposition of text pictures with video frames is different from that of non-text pictures (such as firework pictures) with video frames.

In an exemplary embodiment, step S54, that is, the superimposing the material block to the target position of the video frame includes: superimposing a text material block and an alpha material block corresponding to the text material block on the target positions of the video frame in response to the material block being the text material block including text pictures containing text information, in which the alpha material block includes alpha pictures in one-to-one correspondence to the text pictures of the text material block.

The material picture of the material block and the alpha picture of the alpha material block are superimposed into the second position coordinates of the video frame of the video.

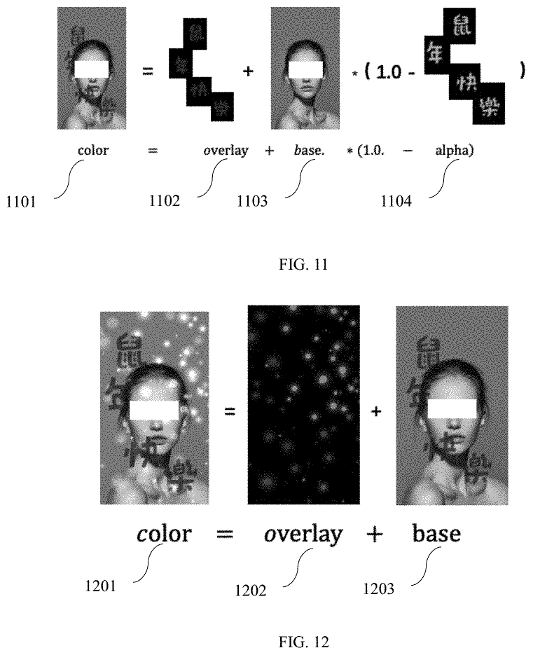

In this embodiment, the superimposition of text pictures is a “normal” superimposition, which needs to use the alpha channel of the text pictures, that is, relates to the superimposition of alpha pictures. Referring to FIG. 11, the “normal” superimposition formula is:

color=overlay+base*(1.0−alpha)

where color 1101 represents a video rendering effect picture after superimposing the text picture, overlay 1102 represents the RGB value of the text picture (text material), which is reflected herein in the left part of the material video in FIG. 6, base 1103 represents the RGB value of the video frame, and alpha 1104 represents the alpha picture corresponding to the text picture, which is reflected herein in the right part of the material video of FIG. 6.

The alpha value ranges from 0 to 1, where 0 represents complete transparency. Assuming that the material picture is completely transparent (overlay is transparent), then base*(1.0−0.0)=base, that is, the final color is the bottom color, that is, the color of the video frame of the video, which is reflected in the part without text in the left picture. For the same reason, 1 represents complete opacity, then the overlay has something, and base*(1.0−1.0)=0.0, that is, the final color is the color of the material picture, in other words, when the material picture is completely opaque, in the end, only the color of the material picture is obtained, and the color of the video frame of the first video will not be seen through the material picture.

In an exemplary embodiment, for the superposition or superimposition of non-text pictures and video frames of the first video, such as the superposition of firework pictures and video frames, the “addition” superposition is adopted, which does not need to use the alpha channel of the firework materials. Referring to FIG. 12, the “addition” superposition formula is:

color=overlay+base

where color 1201 represents a video rendering effect picture after superimposing the text picture and the firework picture, overlay 1202 represents the RGB value of a non-text picture (firework material), which is reflected herein in the middle part of the material video in FIG. 6, and base 1203 represents the RGB value of the video frame after the text picture has been superimposed.

In this embodiment, material pictures with different mixing methods, such as text pictures with text effects and firework pictures with firework effects, are spliced and combined into one material video, achieving the purpose of mixing a plurality of video effects with low memory space occupation.

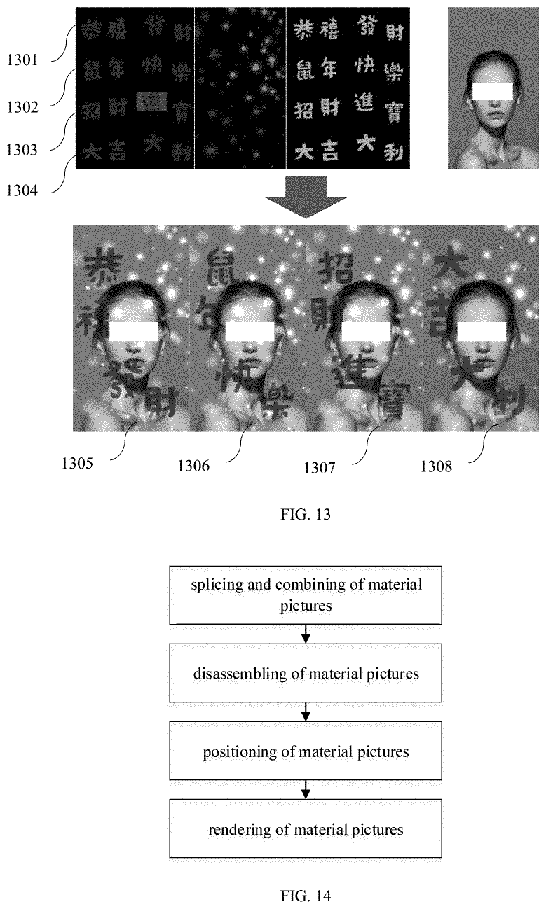

By applying this embodiment, at least two video effects can be spliced and combined into one material video, and video rendering can be performed on the video. For example, assuming that a material video contains text pictures with four sets of text effects of “Gong Xi Fa Cai” 1301, “Shu Nian Kuai Le” 1302, “Zhao Cai Jin Bao” 1303, and “Da Ji Da Li” 1304, and firework pictures with a set of firework effects, one can repeatedly perform the steps of splicing and combining, disassembling, positioning, and superimposing, as shown in FIG. 14, and four kinds of video rendering effect pictures 1305-1308 as shown in FIG. 13 can be obtained, respectively.

With the spatial multiplexing technology of the material video proposed in this embodiment, the material pictures with video effects, especially the text pictures are put into a small grid to optimize the effective use area of the material pictures in the material video. Moreover, the material pictures with various types of video effects are arranged and combined in space. After the device decodes the video, the material pictures can be disassembled, positioned and superimposed by using the rendering method of this embodiment, and a single material video can be used to render a variety of the video effects for the video. In this embodiment, it is possible to greatly optimize the device memory and improve the smoothness of video rendering when the device memory and performance need to be strictly controlled, for example, for some models.

It should be understood that although the individual steps in the flowchart of FIG. 5 are shown sequentially as indicated by arrows, these steps are not necessarily performed in the sequence indicated by the arrows. Unless explicitly stated herein, there is no strict order in which these steps can be performed, and these steps may be performed in other orders. Moreover, at least part of the steps in FIG. 5 may include a plurality of steps or stages, and these steps or stages are not necessarily performed at the same moment, but may be performed at different moments. These steps or stages are not necessarily performed sequentially, but may be performed alternately or alternatively with other steps or at least part of steps or stages within the other steps.

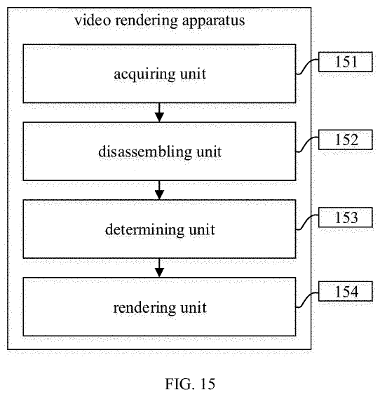

FIG. 15 is a block diagram showing a video rendering apparatus according to an exemplary embodiment. Referring to FIG. 15, the apparatus includes an acquiring unit 151, a disassembling unit 152, a determining unit 153 and a rendering unit 154.

The acquiring unit 151 is configured to acquire a first video which is to be rendered and a material video for rendering the first video, in which the material video is obtained by splicing and combining at least two video effects, and each of the video effects includes a plurality of material pictures. The disassembling unit 152 is configured to disassemble a plurality of material blocks from the material video, each of the material blocks being obtained by sequentially arranging a plurality of material pictures belonging to a same video effect. The determining unit 153 is configured to determine target positions of the material blocks in a video frame of the first video. The rendering unit 154 is configured to acquiring a second video by superimposing the material blocks on the target positions of the video frame to complete video rendering.

In an exemplary embodiment, the rendering unit 154 is configured to superimpose a text material block and an alpha material block corresponding to the text material block on the target position of the video frame in response to the material block being the text material block including text pictures containing text information, in which the alpha material block comprises alpha pictures in one-to-one correspondence to the text pictures of the text material block.

In an exemplary embodiment, the disassembling unit 152 is configured to acquire first position coordinates of each of the material blocks in the material video; and disassemble the material block from the material video according to the first position coordinates.

In an exemplary embodiment, the determining unit 153 is configured to acquire a coordinate mapping relationship, the coordinate mapping relationship being a mapping relationship between the first position coordinates of the material blocks in the material video and second position coordinates of the material blocks in the video frame of the first video; determine the second position coordinates corresponding to the first position coordinates according to the coordinate mapping relationship; and take as the target position a position where the second position coordinates are located.

In an exemplary embodiment, the apparatus further includes: an effect acquiring unit configured to acquire at least two video effects, each of the video effects including a plurality of material pictures; and an splicing and combining unit configured to arrange text pictures belonging to a same text effect and to a same text as a text material block in response to at least one of the video effects being a text effect including text pictures containing text information; generate an alpha material block for the text material block, the alpha material block including alpha pictures in one-to-one correspondence to the text pictures of the text material block; and obtain the material video by performing splicing and combining according to the text material block and the alpha material block.

Regarding the apparatus in the above-mentioned embodiment, the specific manner in which each module performs the operation has been described in detail in the embodiment of the method.

In an exemplary embodiment, there is also provided an electronic device (as, for example, as shown in FIG. 4). The electronic device includes: a processor; and a memory for storing instructions executable by the processor; in which the processor is configured to execute the instructions to perform the video rendering method as described in the foregoing embodiments.

In an exemplary embodiment, there is also provided a non-transitory computer-readable storage medium including instructions, for example, a memory 102 including instructions, in which the instructions are executable by the processor 120 of the device 100 to perform the above-mentioned method. For example, the non-transitory computer-readable storage medium may be ROMs, random access memories (RAMs), CD-ROMs, magnetic tapes, floppy disks, optical data storage devices, and the like.

In an exemplary embodiment, there is provided a computer program product including a computer program stored in a readable storage medium, from which at least one processor of a device is able to read and execute the computer program, so that the device executes the video rendering method described in the above embodiment.

Other embodiments of the present disclosure will readily occur to those skilled in the art upon consideration of the description and practice of the disclosure disclosed herein. This disclosure is intended to cover any variations, uses, or adaptive modifications of this disclosure that follow the general principles of this disclosure and include common general knowledge or conventional techniques in the art not disclosed by this disclosure. The description and examples are to be regarded as being exemplary only, with the true scope and spirit of the disclosure being indicated by the following claims.

It should be understood that the present disclosure is not limited to the precise structures described above and illustrated in the accompanying drawings, and that various modifications and changes may be made without departing from the scope thereof. The scope of the present disclosure is limited only by the appended claims.

What is claimed is:

1. A video rendering method, comprising:
acquiring a first video which is to be rendered and a material video for rendering the first video, wherein the material video is obtained by splicing and combining at least two video effects, and each of the video effects comprises a plurality of material pictures;
disassembling a plurality of material blocks from the material video, each of the material blocks being obtained by sequentially arranging a plurality of material pictures belonging to a same video effect;
determining target positions of the material blocks in a video frame of the first video; and
acquiring a second video by superimposing the material blocks on the target positions of the video frame to complete video rendering.

2. The video rendering method of claim 1, wherein said superimposing the material blocks into the target positions of the video frame comprises:
superimposing a text material block and an alpha material block corresponding to the text material block on the target positions of the video frame in response to the material block being the text material block including text pictures containing text information, wherein the alpha material block comprises alpha pictures in one-to-one correspondence to the text pictures of the text material block.

3. The video rendering method of claim 1, wherein said disassembling a plurality of material blocks from the material video comprises:
acquiring first position coordinates of each of the material blocks in the material video; and
disassembling the material blocks from the material video according to the first position coordinates.

4. The video rendering method of claim 3, wherein said determining the target position of the material blocks in the video frame of the first video comprises:
acquiring a coordinate mapping relationship, the coordinate mapping relationship being a mapping relationship between the first position coordinates of the material blocks in the material video and second position coordinates of the material blocks in the video frame of the first video;
determining the second position coordinates corresponding to the first position coordinates according to the coordinate mapping relationship; and
determining the target position based on a position where the second position coordinates are located.

5. The video rendering method of claim 1, wherein said acquiring the first video and the material video for rendering the first video comprises:
acquiring at least two video effects;
arranging text pictures belonging to a same text effect and to a same text as a text material block in response to at least one of the video effects being a text effect including text pictures containing text information;
generating an alpha material block for the text material block, the alpha material block comprising alpha pictures in one-to-one correspondence to the text pictures of the text material block; and
obtaining the material video by performing splicing and combining according to the text material block and the alpha material block.

6. An electronic device, comprising:
a processor;
a memory for storing instructions executable by the processor;
wherein the processor is configured to execute the instructions to perform the following operations:
acquiring a first video which is to be rendered and a material video for rendering the first video, wherein the material video is obtained by splicing and combining at least two video effects, and each of the video effects comprises a plurality of material pictures;
disassembling a plurality of material blocks from the material video, each of the material blocks being obtained by sequentially arranging a plurality of material pictures belonging to a same video effect;
determining target position of the material blocks in a video frame of the first video; and
acquiring a second video by superimposing the material blocks on the target positions of the video frame to complete video rendering.

7. The electronic device of claim 6, wherein the processor is configured to execute the instructions to perform the following operations:
superimposing a text material block and an alpha material block corresponding to the text material block on the target positions of the video frame in response to the material block being the text material block including text pictures containing text information, wherein the alpha material block comprises alpha pictures in one-to-one correspondence to text pictures of the text material block.

8. The electronic device of claim 6, wherein the processor is configured to execute the instructions to perform the following operations:
acquiring first position coordinates of each of the material blocks in the material video; and
disassembling the material blocks from the material video according to the first position coordinates.

9. The electronic device of claim 8, wherein the processor is configured to execute the instructions to perform the following operations:
acquiring a coordinate mapping relationship, the coordinate mapping relationship being a mapping relationship between the first position coordinates of the material blocks in the material video and second position coordinates of the material blocks in the video frame of the first video;
determining the second position coordinates corresponding to the first position coordinates according to the coordinate mapping relationship; and
determining the target position based on a position where the second position coordinates are located.

10. The electronic device of claim 6, wherein the processor is configured to execute the instructions to perform the following operations:
acquiring at least two video effects;
arranging text pictures belonging to a same text effect and to a same text as a text material block in response to at least one of the video effects being a text effect including text pictures containing text information;
generating an alpha material block for the text material block, the alpha material block comprising alpha pictures corresponding to the text pictures of the text material block; and
obtaining the material video by performing splicing and combining according to the text material block and the alpha material block.

11. A storage medium having stored therein instructions that, when executed by a processor of an electronic device, cause the electronic device to perform the following operations:
acquiring a first video which is to be rendered and a material video for rendering the first video, wherein the material video is obtained by splicing and combining at least two video effects, and each of the video effects comprises a plurality of material pictures;
disassembling a plurality of material blocks from the material video, each of the material blocks being obtained by sequentially arranging a plurality of material pictures belonging to a same video effect;
determining target positions of the material blocks in a video frame of the first video; and
acquiring a second video by superimposing the material blocks on the target positions of the video frame to complete video rendering.

12. The storage medium of claim 11, wherein when the instructions in the storage medium are executed by the processor of the electronic device, the electronic device is configured to perform the following operations:
superimposing a text material block and an alpha material block corresponding to the text material block on the target positions of the video frame in response to the material block being the text material block including text pictures containing text information, wherein the alpha material block comprises alpha pictures in one-to-one correspondence to the text pictures of the text material block.

13. The storage medium of claim 11, wherein when the instructions in the storage medium are executed by the processor of the electronic device, the electronic device is configured to perform the following operations:
acquiring first position coordinates of each of the material blocks in the material video; and
disassembling the material blocks from the material video according to the first position coordinates.

14. The storage medium of claim 13, wherein when the instructions in the storage medium are executed by the processor of the electronic device, the electronic device is configured to perform the following operations:
acquiring a coordinate mapping relationship, the coordinate mapping relationship being a mapping relationship between the first position coordinates of the material blocks in the material video and second position coordinates of the material blocks in the video frame of the first video;
determining the second position coordinates corresponding to the first position coordinates according to the coordinate mapping relationship; and
determining the target position based on a position where the second position coordinates are located.

15. The storage medium of claim 11, wherein when the instructions in the storage medium are executed by the processor of the electronic device, the electronic device is configured to perform the following operations:
acquiring at least two video effects;
arranging text pictures belonging to a same text effect and to a same text as a text material block in response to at least one of the video effects being a text effect including text pictures containing text information;
generating an alpha material block for the text material block, the alpha material block comprising alpha pictures corresponding to the text pictures of the text material block; and
obtaining the material video by performing splicing and combining according to the text material block and the alpha material block.
